(19) United States
(12) Patent Application Publication
(10) Pub. No.: US 2022/0013030 A1
(43) Pub. Date: Jan. 13, 2022

(54) EXTENDED SERVICE-PROVIDING SYSTEM AND METHOD FOR PROVIDING ARTIFICIAL INTELLIGENCE PREDICTION RESULTS FOR EXTENDED EDUCATION CONTENTS THROUGH API ACCESS INTERFACE SERVER

(71) Applicant: RIIID INC., Seoul (KR)

(72) Inventors: Young Ku LEE, Seoul (KR); Ga Young PARK, Gyeonggi-do (KR); Dong Min SHIN, Seoul (KR); Jung Hyun CHO, Seoul (KR)

(21) Appl. No.: 17/373,726

(22) Filed: Jul. 12, 2021

(30) Foreign Application Priority Data
Jul. 13, 2020 (KR) 10-2020-0086318
Jun. 24, 2021 (KR) 10-2021-0082307

(51) Int. Cl. G09B 7/06; G09B 7/02; G06F 21/31; G06K 9/62

(52) U.S. Cl. CPC G09B 7/06; G09B 7/02; G06F 2221/2141; G06K 9/6263; G06F 21/31

(57) ABSTRACT

Disclosed is an extended service-providing system which provide an artificial intelligence prediction result associated with extended educational contents via an API access interface server, and the system may include an access interface server to communicate with an extended service server that provides the extended educational contents to a terminal of a user, and a learning content artificial intelligence server to communicate with the access interface server, and the access interface server determines whether the user has an access authority to use the learning content artificial intelligence server if an API transmitted from the terminal is received via the extended service server, and if the user is identified as having the access authority, the learning content artificial intelligence server transmits an artificial intelligence prediction result associated with the extended educational contents to the extended service server via the access interface server, in response to the API transmitted from the terminal.

### CROSS REFERENCE TO RELATED APPLICATION

This application claims priority from Korean Patent Application No. 10-2020-0086318 filed on Jul. 13, 2020 and Korean Patent Application No. 10-2021-0082307 filed on Jun. 24, 2021 in the Korean Intellectual Property Office, the disclosure of which is incorporated herein by reference in its entirety.

### BACKGROUND OF THE INVENTION

### 1. Field of the Invention

The present disclosure relates to an extended service-providing system and method which provide an artificial intelligence prediction result associated with extended educational contents via an application programming interface (API) access interface server and, more particularly, to a disclosure that enables an extended service server having an access authority to utilize an artificial intelligence prediction result through an API that requests various tasks, irrespective of the type of educational content (TOEIC, SAT, a licensed real estate agent examination, a life planner examination, the college scholastic ability text, . . . , or the like).

### 2. Description of the Prior Art

Recently, the Internet and electronic devices are actively utilized in many fields and the education environment is also changing rapidly. Particularly, as various education media develop, learners are able to select and use a wide range of learning methods. Among them, an Internet-based education service has the advantage of being able to provide an education service at low cost without constraints of time and space, and thus, the internet-based education service is positioned as a major teaching and learning scheme.

To meet the trend, a customized education service has diversified, which an offline education service could not provide due to limited human and material resources. For example, an educational content which is subdivided based on the personality and capability of a learner is provided using artificial intelligence and thus, an educational content based on the personal capability of a learner may be provided beyond a standardized education method.

In an online education service based on artificial intelligence, a correct answer rate and predicted scores may be predicted via an artificial intelligence model which has trained with question information associated with a predetermined educational content (e.g., TOEIC) and question solving data of a user. In the process, a base system for providing a service is prepared, in addition to a design, authentication, an authority, a payment, and a data pipeline associated with an artificial intelligence model.

Service providers which desire to provide an artificial intelligence prediction result associated with an educational content may not have the above-described base system and thus, they need to design an artificial intelligence model for each educational content (a licensed real estate agent examination, a life planner examination, the college scholastic ability text, . . . , or the like) and need to prepare a base system, which is a drawback. In addition, the education service providers may have difficulty in developing an artificial intelligence model since they generally have no expertise and are not skilled in the art of developing an artificial intelligence model.

### SUMMARY OF THE INVENTION

The present disclosure has been made in order to solve the above-mentioned problems in the prior art and provides a method and a system for providing an extended service, which enables use of an already established learning content artificial intelligence server via an access interface server that utilizes an API, and enables utilization of an artificial intelligence prediction result irrespective of the type of educational content.

The present disclosure provides a method and a system for providing an extended service, which provides a customized artificial intelligence prediction result for each educational content by independently making an artificial intelligence model to perform training for each educational content and inferring a prediction result.

The present disclosure provides a method and a system for providing an extended service, which can perform centralized management on data in an integrated learning content artificial intelligence server when providing different extended services based on a client ID.

In accordance with an aspect of the present disclosure, there is provided an extended service-providing system that provides an artificial intelligence prediction result associated with an extended education content via an API access interface server, wherein the extended service-providing system that provides an artificial intelligence prediction result associated with an extended education content using an API may include: an access interface server to determine whether an access authority to use a learning content artificial intelligence server is allowed if an API is received from an extended service server that provides an extended educational content; and a learning content artificial intelligence server to provide an artificial intelligence prediction result associated with an extended educational content in response to the API if the access authority is identified as being allowed.

In accordance with an aspect of the present disclosure, there is provided an extended service providing method that provides an artificial intelligence prediction result associated with an extended educational content via an API access interface server, wherein the extended service providing method that provides an artificial intelligence prediction result associated with an extended educational content using an API may include: receiving an API from an extended service server that provides an extended educational content; if the API is received, determining whether an access authority to use a learning content artificial intelligence server is allowed; and if the access authority is identified as being allowed, providing an artificial intelligence prediction result associated with an extended educational content in response to the API.

According to an embodiment of the present disclosure, a learning content artificial intelligence server already established can be used via an access interface server that utilizes an API, and thus, an artificial intelligence prediction result can be utilized, irrespective of the type of educational service.

According to an embodiment, an artificial intelligence model performs training independently for each educational content and a prediction result is inferred and thus, a customized artificial intelligence prediction result may be provided for each educational content.

According to an embodiment of the present disclosure, an integrated learning content artificial intelligence server can perform centralized management on data when providing different extended services based on a client ID.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a diagram illustrating an extended service-providing system according to an embodiment of the present disclosure;

FIG. 2 is a diagram illustrating the configuration of an extended service storage of FIG. 1;

FIG. 3 is a diagram illustrating operation of an extended service-providing system in detail according to an embodiment of the present disclosure;

FIG. 4 is a diagram illustrating an operation of converting data using a client ID and performing an artificial intelligence prediction, in detail according to an embodiment of the present disclosure;

FIG. 5 is a flowchart illustrating a process of registering and inquiring of question data according to an embodiment of the present disclosure;

FIG. 6 is a flowchart illustrating a process of performing an artificial intelligence prediction based on question solving data and artificial intelligence model information according to an embodiment of the present disclosure;

FIG. 7 is a diagram illustrating a process of inquiring of the amount of API used, according to an embodiment of the present disclosure; and

FIG. 8 is a diagram illustrating an example of the configuration of hardware of a computing device capable of embodying servers according to embodiments of the present disclosure.

### DESCRIPTION OF THE EXEMPLARY EMBODIMENTS

Hereinafter, reference will now be made to example embodiments, which are illustrated in the accompanying drawings, wherein like reference numerals may refer to like components throughout and redundant description thereof will be omitted.

It will be understood that when an element is referred to as being “connected” or “coupled” to another element, it may be directly connected or coupled to the other element or intervening elements may be present.

In addition, when detailed descriptions related to a well-known art are identified as making the spirit of the embodiments disclosed in the present specification ambiguous, the detailed descriptions will be omitted herein. In addition, the attached drawings are merely for enabling a sufficient understanding of embodiments disclosed in the present specification, and there is not intent to limit technical idea disclosed in the present specification to the attached drawings. On contrary, the technical idea is to cover all modifications, equivalents, and alternatives falling within the spirit and scope of the present disclosure.

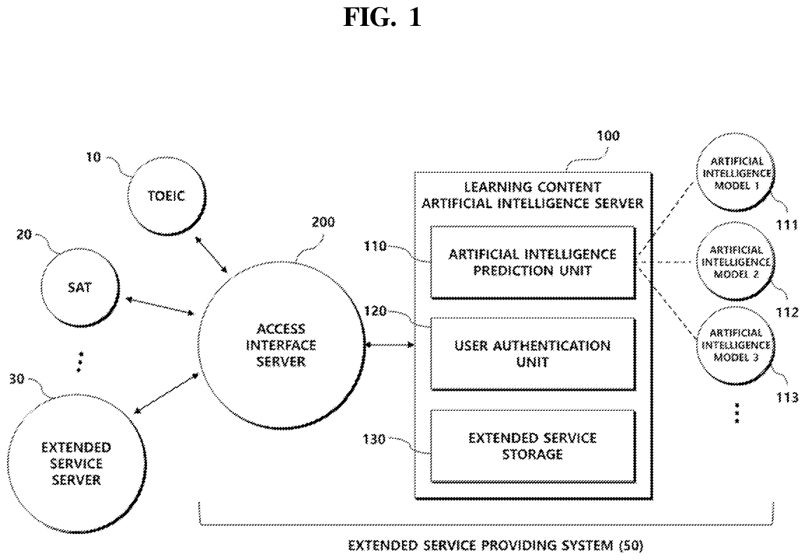

FIG. 1 is a diagram illustrating an extended service-providing system according to an embodiment of the present disclosure.

Referring to FIG. 1, an extended service-providing system 50 may include an access interface server 200 and a learning content artificial intelligence server 100. The access interface server 200 may assign an authority to access to the learning content artificial intelligence server 100, to a server 30 of an extended service that a user desires to apply, such as TOEIC 10, SAT 20, or others.

A method in which the access interface server 200 assigns an access authority may be performed via an API. An application programming interface (API) may be the definition of rules for accessing the learning content artificial server 100. The API is provided in the form of a language or message used when an application program communicates with an operating system or a system program such as a database management system, and may be implemented to call a function that provides a connection to a predetermined sub-routine for implementation in a program.

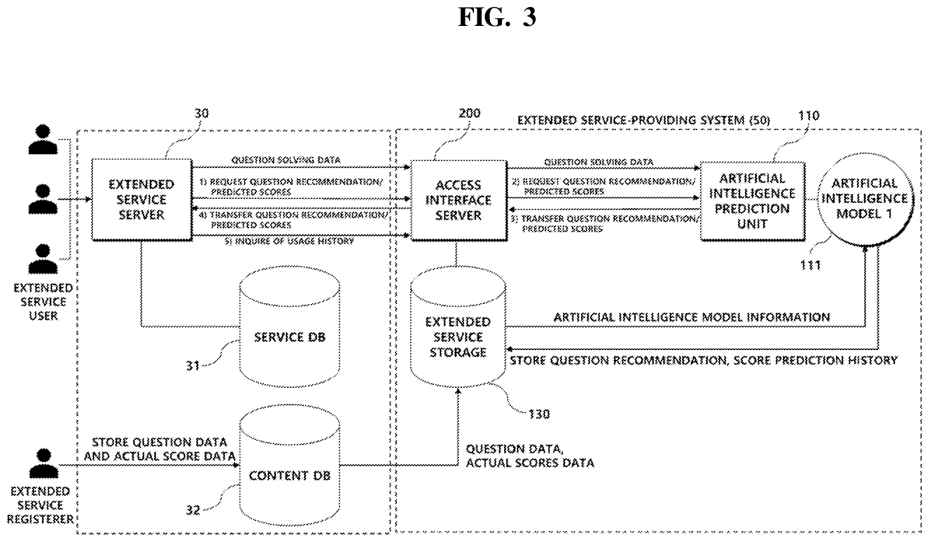

According to an embodiment, a user (e.g., an “extended service registerer” and an “extended service user” of FIG. 3) of the extended service server 30 may deliver a predetermined API (e.g., a “registration API”, an “inquiry API”, an “artificial intelligence usage API”, and a “usage amount identification API”) to the access interface server 200 by using a user equipment (not illustrated). Accordingly, the user is capable of registering program data, making an inquiry, and receiving an artificial intelligence prediction result, and is capable of identifying charging information by identifying the amount of API used.

According to an embodiment, the registration API may include a content push registration API, a content pull registration API, and a tag registration API.

The content push registration API may be an API that registers or updates a content in real time. The content pull registration API may be an API that calls data stored in the content database 32 in a database pulling manner. The tag registration API is an API for registering a tag for the use of an artificial intelligence model.

According to an embodiment, the inquiry API may include a content inquiry API, a content state change API, a subject information inquiry API, a subject registration API, and a tag list inquiry API.

The content inquiry API may be an API for identifying a registered content and identifying information for each content. The content state change API may be an API that excludes an already registered content from the range of contents to be recommended. The subject information inquiry API may be an API for inquiring of a registered subject list or tag information registered with a subject. The subject registration API may be an API for registering a new subject. The tag list inquiry API may be an API for inquiring of a registered tag list and tag information.

In this instance, in the case of TOEIC, a content is a question (a TOEIC question), a subject is a course or the type of question (TOEIC part 1, part 2, . . . , or the like), and a tag is a subject matter (a noun, a verb, an adverb, a preposition, grammar, listening, writing, reading, or a sentence pattern). In the case of a mathematical problem, a content is a question (mathematical problem), a subject is a course or the type of question (math), and a tag is a subject matter (progression, differentiation, integration).

According to an embodiment, the artificial intelligence usage API may include one or more APIs among a predicted score request API, a predicted correct answer rate request API, a question recommendation API, a weak tag recommendation API, a scholastic aptitude exam question recommendation API, and a learning record transmission API.

The predicted score request API may be an API for providing predicted scores at the point in time at which a user inquires of the same. The predicted correct answer rate request API may be an API for providing a predicted correct answer rate at the point in time at which a user inquires of the same. The question recommendation API may be an API for recommending a question appropriate for a user. The weak tag recommendation API may be an API for providing, as a tag, a vulnerable field of a user identified based on question solving data. The scholastic aptitude exam question recommendation API may be an API for recommending questions for a scholastic aptitude exam. The learning record transmission API may be an API for transmitting the learning records of a user in real time to advance an artificial intelligence model.

According to an embodiment, the usage amount identification API may be used for performing monitoring or identifying charging, and may identify the amount of API (e.g., number of times that an API is used, amount of time during which an API is used) used in each day.

In an online education service based on artificial intelligence, a correct answer rate, predicted scores, and the like may be predicted via an artificial intelligence model which has trained based on question information associated with a predetermined educational content (e.g., TOEIC) and question solving data of a user. In the process, a base system for providing a service is prepared, in addition to a design, authentication, an authority, a payment, and a data pipeline associated with an artificial intelligence model.

The base system may be in the state of being used universally by being shared with the extended service server 30 associated with another educational content, irrespective of the type of educational content (domain) That is, the base system may be extended to other educational contents (a licensed real estate agent examination, a life planner examination, the college scholastic ability text, . . . , or the like), and may be used for inferring an artificial intelligence prediction result.

A conventional educational content providers have been suffered to design an artificial intelligence model for each educational content and to prepare a base station thereof, in order to provide an artificial intelligence-based prediction result. The educational content providers have difficulty in developing an artificial intelligence model since they do not have skilled art and specialty in developing an artificial intelligence model, and cannot provide an advanced artificial intelligence prediction result.

An extended service-providing system 50 according to an embodiment of the present disclosure may allow the extended service server 30 having an authority to access the learning content artificial intelligence server 100 to access the learning content artificial intelligence server 100 via an API access interface server, and may provide an artificial intelligence prediction result associated with an extended service of the extended service server 30 to the extended service server 30.

According to an embodiment, a representational state transfer (REST) API may be used as an API. REST is an architecture style that enables computers to communicate with each other over a network. The REST API is based on an Internet identifier (uniform resource identifier (URI)) and a HTTP protocol.

Users of an extended service (a licensed real estate agent examination, a life planner examination, the college scholastic ability text, . . . , or the like) may use the learning content artificial intelligence server 100 via the access interface server 200, and may receive predicted scores, predicted correct answer rates, recommended questions, recommended weak tags, and recommended scholastic aptitude examination questions of the users for each extended service.

In response to an API received from an authenticated user, the learning content artificial intelligence server 100 may provide an artificial intelligence prediction result to the user and may store user log. The user log may include a question recommendation history and a score prediction history.

The learning content artificial intelligence server 100 may include an artificial intelligence prediction unit 110, a user authentication unit 120, and an extended service storage 130.

The artificial intelligence prediction unit 110 may perform an artificial intelligence prediction using question solving data received from a user, based on artificial intelligence model information. The artificial intelligence prediction may use one or more of various artificial intelligence models 111, 112, and 113.

An artificial intelligence model to be used may be determined based on the purpose of use, the type of educational content, or the like. For example, artificial intelligence model 1 111 may be a model appropriate for solving questions, and artificial intelligence model 2 112 may be a model appropriate for recommending a lecture.

An artificial intelligence model may use one of the various implementable artificial intelligence model structures. For example, by taking into consideration that most data is time series data, which is the feature of educational data, a transformer model may be used among various artificial intelligence structures that model time-series data.

The transformer model trains the temporal feature of time serial data, and models association among educational data according to the self-attention mechanism, and thus, the transformer model may be optimized for the field of education. The transformer model may separate an encoder and a decoder, may input question data to the encoder, and may input question solving data of a user to the decoder.

The user authentication unit 120 may determine whether a user (an “extended service registerer” and an “extended service user” of FIG. 3) who desires to use the learning content artificial intelligence server 100 is a registered user. Various user authentication methods, such as a method of determining whether a user has subscribed to a service based on an ID and a password, and the like may be used for user authentication.

The extended service storage 130 may store artificial intelligence model information which is information associated with an artificial intelligence model to be used for each extended service. The artificial intelligence model information may be determined based on user log such as a previous question recommendation history, a score recommendation history, and the like of a user, and may include parameters for optimizing an artificial intelligence model for each extended service.

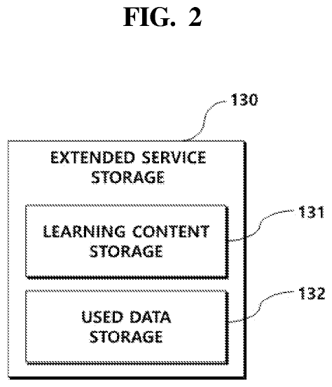

FIG. 2 is a diagram illustrating the configuration of the extended service storage 130 of FIG. 1.

Referring to FIG. 2, the extended service storage 130 may include a learning content storage 131 and a used data storage 132.

The learning content storage 131 may store question data and actual score data that an extended service registerer registers at the initial stage of a service, and may store a question recommendation history and a score prediction history which are produced as an artificial intelligence prediction result. In addition, the learning content storage 131 may store artificial intelligence model information including an artificial intelligence model parameter for each extended service.

The used data storage 132 may store the amount of API used by an extended service user. The amount of API used may be a criterion for charging for the use of the learning content artificial intelligence server 100.

The cost charged may be determined differently based on the type of API used. For example, the cost charged for an artificial intelligence usage API may be higher than the cost charged for an inquiry API, when the same amount of API is used.

FIG. 3 is a diagram illustrating operation of the extended service-providing system 50, in detail according to an embodiment of the present disclosure.

Referring to FIG. 3, although the service database 31 and the content database 32 may be illustrated as being separated from the extended service server 30, they may be included in the extended service server 30 depending on an embodiment.

The service database 31 may store personal information and question solving data of extended service users. The personal information may include membership information, authentication information, and the like.

The content database 32 may store question data and actual score data registered by an extended service registerer. According to an embodiment, the content database 32 may be omitted. In this instance, the extended service registerer may directly store question data and actual store data in the extended service storage 130 via a content push registration API.

The question data is a concept including all contents that inclusively used for learning. In the case of TOEIC, question data may be contents configured for each subject matter (a noun, a verb, an adverb, a preposition, grammar, listening, writing, reading, a sentence pattern, and the like) and the type of question (TOEIC part 1, part 2, . . . , or the like), and may be classified based on the type of learning (question solving, a video lecture, a text lecture, and the like). The question data may be a concept that compasses a question content, a lecture content, and the like. The question data is not limited to TOEIC questions, and may include all types of examinations that require a user to solve questions such as SAT, a licensed real estate agent examination, a life planner examination, the college scholastic ability text, . . . , and the like.

The actual score data may be data related to the actual scores of users which are to be used for making an initial artificial intelligence model to train. For example, the extended service-providing system 50 may request actual score data of at least 100 users as data to be used for making the initial artificial intelligence model to train. The more questions an extended service user solves, the more advance the artificial intelligence model gets from the initial artificial intelligence model and thus, an artificial intelligence model having a high accuracy may be embodied.

The extended service storage 130 may retrieve and store question data and actual store data via a registration API. Particularly, if a content pull registration API is received, the extended service storage 130 may retrieve question data and actual score data from the content database 32 according to a pulling scheme, and may store the same.

Alternatively, if a content push registration API is received, the extended service storage 130 may receive a content in real time from an extended service registerer without passing through the content database 32, and may store the same or perform updating.

The problem data and the actual score data stored in the extended service storage 130 may be used for making an artificial intelligence model to train. In addition, the question data and the actual score data may be transmitted as artificial intelligence model information to the artificial intelligence model 111, and may be used as information for artificial intelligence prediction.

The question data and actual score data are received from an extended service registerer, are stored in the extended service storage 130, and are used for making the artificial intelligence model 111 to perform training, and then, extended service users are can start solving questions in earnest.

Extended service users may solve questions received from the extended service server 30, and may transfer question solving data. The question solving data may be stored in the extended service storage 130 via the access interface server 200, and may be transferred to the artificial intelligence prediction unit 110 via the access interface server 200 so as to be used as basic data for artificial intelligence prediction.

Subsequently, in response to a request from an extended service user, the extended service server 30 may transfer a request for question recommendation/predicted scores via an artificial intelligence usage API. The access interface server 200 may receive question recommendation/predicted scores from the artificial intelligence prediction unit 110, and may provide the same to the extended service user via the extended service server 30.

If the extended service server 30 transfers a usage amount identification API to the access interface server 200 in response to a request for identifying the amount of API used by an extended service user, the access interface server 200 may identify the amount of API input and output, and may provide a usage history associated with the amount of API used to the extended service server 30.

According to an embodiment of the present disclosure, the extended service-providing system 50 may connect the plurality of extended service servers 30 to the access interface server 200 in parallel, and may not need to separately establish an artificial intelligence model for each extended service, which is an advantage, and may enable the use of an already established learning content artificial intelligence server 100 via the access interface server 200 that utilizes an API, and thus, an artificial intelligence prediction result may be utilized, irrespective of the type of educational content.

In addition, according to an embodiment, the extended service-providing system 50 may make an artificial intelligence model to perform training independently for each educational content and may infer a prediction result and thus, may provide a customized artificial intelligence prediction result for each educational content.

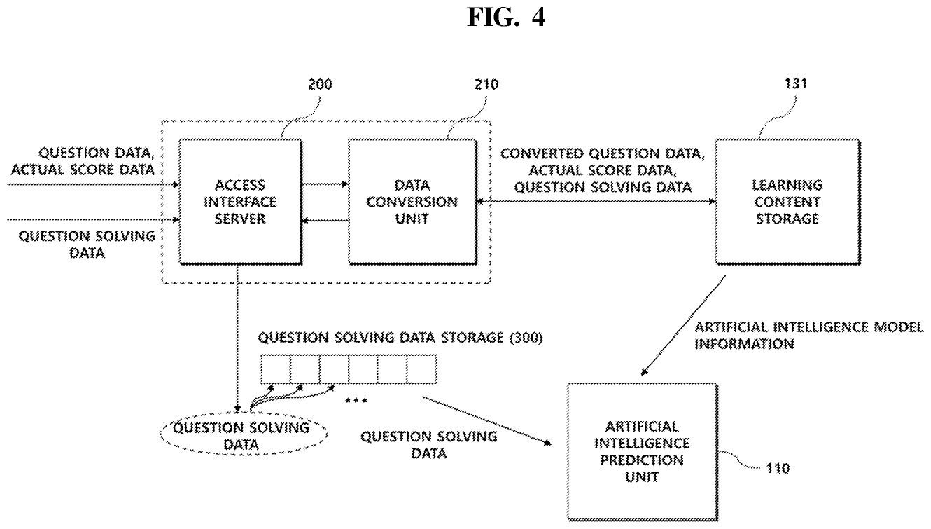

FIG. 4 is a diagram illustrating an operation of converting data using a client ID and performing an artificial intelligence prediction, in detail according to an embodiment of the present disclosure.

Referring to FIG. 4, although the access interface server 200 is illustrated as an entity independent from the data conversion unit 210, the data conversion unit 210 may be included in the access interface server 200 according to an embodiment.

If the access interface server 200 receives question data and actual score data from an extended service registerer, and receives question solving data from an extended service user, the access interface server 200 may transfer the same to the learning content storage 131. In this instance, the learning content storage 131 may need to integrally store and manage data associated with a plurality of extended services, and thus, may need to classify the data when storing the same.

Therefore, the data conversion unit 210 may add a client ID assigned for each extended service to question data, actual score data, and question solving data. The client ID may be added in a manner of recording in a field designated for each data, adding metadata, or recording in a header, or the like.

The question data, actual score data, question solving data to which a client ID is assigned may be converted question data, converted actual score data, and converted question solving data, respectively. Since the data is managed by assigning a client ID, the question data, the actual score data, and the question solving data may be classified and managed for each extended service.

The question solving data storage 300 may queue question solving data in order of solving questions, and may store the queued data in each storage space, and may transfer the same to the artificial intelligence prediction unit 110 when performing an artificial intelligence prediction later. According to an embodiment, the question solving data storage 300 may be included in the extended service storage 130, may be included in the access interface server 200, or may be present as independent entity from the access interface server 200 and the extended service storage 130.

Although, in FIG. 4, it is illustrated that the question solving data is stored in the question solving data storage 300 without passing through the data conversion unit 210, question solving data to which a client ID is added by the data conversion unit 210 may also be stored in the question solving data storage 300 according to an embodiment.

With reference to artificial intelligence model information received from the learning content storage 131, the artificial intelligence prediction unit 110 may produce an artificial intelligence prediction result from the question solving data received from the question solving data storage 300.

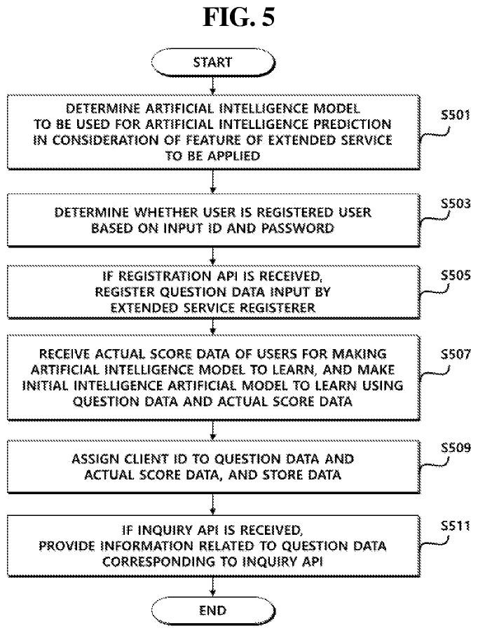

FIG. 5 is a flowchart illustrating a process of registering and making an inquiry of question data according to an embodiment of the present disclosure.

Referring to FIG. 5, in operation S501, the extended service-providing system 50 may determine an artificial intelligence model to be used for artificial intelligence prediction by taking into consideration the feature of an extended service to be applied. The artificial intelligence model to be used may be determined based on the purpose of use, the type of educational content, or the like. For example, artificial intelligence model 1 may be a model appropriate for solving questions, and artificial intelligence model 2 may be a model appropriate for recommending a lecture.

An artificial intelligence model may use one of the various implementable artificial intelligence model structures. For example, by taking into consideration that most data is time series data, which is the feature of educational data, a transformer model may be used among various artificial intelligence structures that model time-series data.

In operation S503, the extended service-providing system 50 may determine whether an extended service user/extended service registerer is a previously registered user based on an input ID and password. If the determination result shows that the extended service user/extended service registerer is a registered user, the method may proceed with operation S505. If the extended service user/extended service registerer is not a registered user, the method may block access to prevent subsequent operations S505 to S511 from being performed.

In operation S505, if a registration API is received from the extended service registerer, the extended service-providing system 50 may register question data input by the extended service registerer. The registration API may include a content registration API, a subject registration API, and a tag registration API.

Here, the content registration API may be classified as a content push registration API and a content pull registration API. The content push registration API may be an API that registers or updates a content in real time, and may not pass through the content database 32. Conversely, the content pull registration API is based on a database pulling scheme, and may be an API used when the extended service-providing system 50 retrieves data stored in the content database 32 of the extended service registerer.

In operation S507, the extended service-providing system 50 may receive the actual score data of users to be used for making an artificial intelligence model to train, and may make an initial artificial intelligence model to train by using the registered question data and the received actual score data. Subsequently, the more questions the extended service users solve, the artificial intelligence model is further trained, and thus, the accuracy may be increased.

In operation S509, the extended service-providing system 50 may assign a client ID to the question data and the actual score data, and may store the same. The client ID may be an unique ID which differs for each extended service.

In operation S511, if an inquiry API is received from the extended service user, the extended service-providing system 50 may provide information associated with question data corresponding to the inquiry API to the extended service user. The inquiry API may include a content inquiry API, a subject inquiry API, and a tag inquiry API.

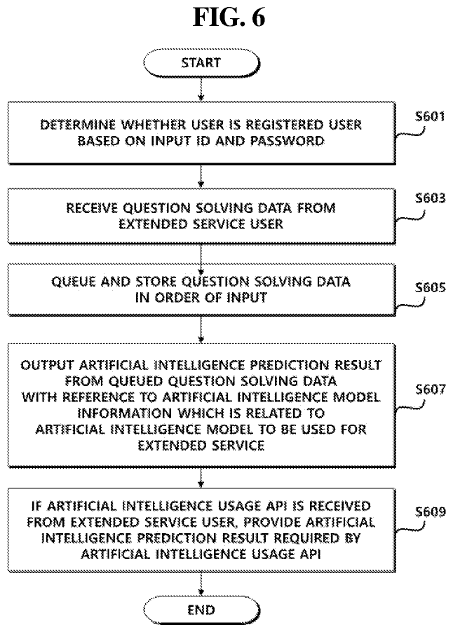

FIG. 6 is a flowchart illustrating a process of performing an artificial intelligence prediction based on question solving data and artificial intelligence model information according to an embodiment of the present disclosure.

Referring to FIG. 6, in operation S601, the extended service-providing system 50 may determine whether an extended service user/extended service registerer is a previously registered user based on an input ID and password. If the determination result shows that the extended service user/extended service registerer is a registered user, the method may proceed with operation S603. If the extended service user/extended service registerer is not a registered user, the method may block access to prevent subsequent operations S603 to S609 from being performed.

The extended service-providing system 50 may receive question solving data from an extended service user in operation S603, and may queue and store the question solving data in order of input in operation S605.

In operation S607, the extended service-providing system 50 may output an artificial intelligence prediction result from the queued question solving data with reference to artificial intelligence model information. The artificial intelligence model information may be information associated with an artificial intelligence model to be used for extended service. The artificial intelligence model information may be determined based on user log such as a previous question recommendation history, a score prediction history, and the like of a user, and may include parameters for optimizing an artificial intelligence model for each extended service.

In operation S609, if an artificial intelligence usage API is received from the extended service user, the extended service-providing system 50 may provide an artificial intelligence prediction result corresponding to the received artificial intelligence usage API.

The artificial intelligence usage API may include a predicted score request API for providing predicted scores at the point in time of inquiry by a user, a predicted correct answer rate request API for providing a predicted correct answer rate at the point in time of inquiry by a user, a question recommendation API for recommending a question appropriate for a user, a weak tag recommendation API for providing, as a tag, a vulnerable field of a user identified based on question solving data, a scholastic aptitude exam question recommendation API for recommending a scholastic aptitude exam question, and a learning record transmission API for transmitting a learning record of a user in real time in order to advance an artificial intelligence model.

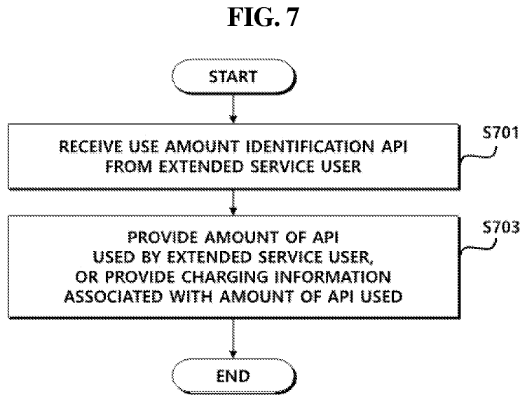

FIG. 7 is a diagram illustrating a process of inquiring of the amount of API used, according to an embodiment of the present disclosure.

Referring to FIG. 7, in operation S701, the extended service-providing system 50 may receive a usage amount identification API from an extended service user.

In operation S703, the extended service-providing system 50 that receives the usage amount identification API may provide the amount of API used by the extended service user or may provide charging information associated with the amount of API used.

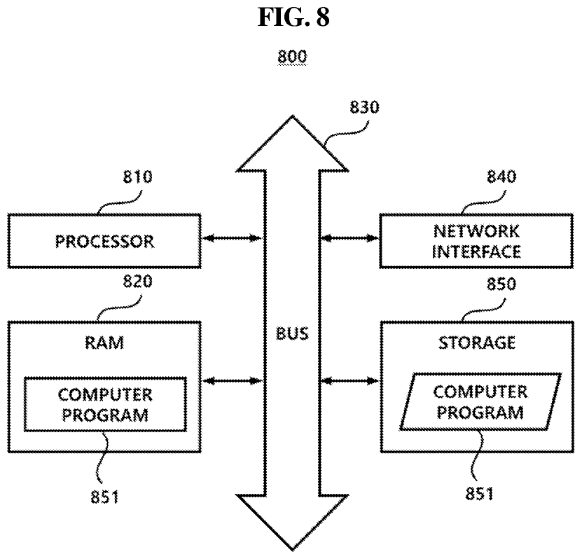

With reference to FIGS. 1 to 7, the extended service-providing system 50 and the method thereof have been described according to an embodiment of the present disclosure. Hereinafter, with reference to FIG. 8, a computing device capable of embodying the servers 30, 100, and 200 according to some embodiments of the present disclosure is described.

FIG. 8 is a diagram illustrating an example of the configuration of hardware of a computing device which may embody servers according to embodiments of the present disclosure.

Referring to FIG. 8, a computing device 800 may include one or more processors 810, a storage 850 storing a computer program 851, a memory 820 that loads the computer program 851 implemented by the processor 810, a bus 830, and a network interface 840. Here, only elements related to the embodiments of the present disclosure are illustrated in FIG. 8. Therefore, it is apparent to those skilled in the art that other widely used elements, in addition to the elements illustrated in FIG. 8, may be further included.

The processor 810 may control overall operation of each element of the computing device 800. The processor 810 may be configured to include a central processing unit (CPU), a microprocessor unit (MPU), a microcontroller unit (MCU), a graphic processing unit (GPU), or a processor of a type well known to the technical field of the present disclosure. In addition, the processor 810 may perform an operation associated with at least one computer program to implement an extended service providing method according to embodiments of the present disclosure. The computing device 800 may include one or more processors.

The memory 820 may store data that supports various functions of the computing device 800. The memory 820 may store multiple computer programs (app, application program, or application software) operating in the computing device 800, and one or more among data, instructions, and information for operating the computing device 800. At least some of the computer programs may be downloaded from an external device (not illustrated). In addition, at least some of the computer programs may be contained in the computing device 800 when the computer device is released, to support the basic function of the computing device 800 (e.g., sending and receiving a message). The memory 820 may load one or more computer programs 851 from the storage 850 to implement the extended service providing method according to the embodiments of the present disclosure. In FIG. 8, a random access memory (RAM) is illustrated as an example of the memory 820.

The bus 830 may provide a function of performing communication among the elements of the computing device 800. The bus 830 may be embodied as various types of buses such as an address bus, a data bus, a control bus, and the like.

The network interface 840 may support wired and wireless Internet communication of the computing device 800. In addition, the network interface 840 may support various communication schemes in addition to the Internet communication. To this end, the network interface 240 may be configured, including a communication module which is well known to the technical field of the present disclosure.

The storage 850 may non-temporarily store one or more computer programs 851. The storage 850 may be configured, including a non-volatile memory such as read only memory (ROM), erasable programmable ROM (EPROM), electrically erasable programmable ROM (EEPROM), a flash memory, and the like, a hard disk, a detachable disk, or a computer readable recording medium of a type well known to the technical field of the present disclosure.

With reference to FIG. 8, an example of a computing device which may embody servers according to embodiments of the present disclosure has been described. The computing device illustrated in FIG. 8 may embody a user equipment according to some embodiments of the present disclosure, in addition to embodying servers according to some embodiments of the present disclosure. In this instance, the computing device 800 may further include an input unit and an output unit, in addition to the elements illustrated in FIG. 8.

The input unit may include a camera for receiving an image signal, a microphone for receiving an audio signal, and a user input unit for receiving information from a user. The user input may include one or more keys among a touch key and a mechanical key. Image data collected via the camera or audio signals collected via the microphone may be analyzed, and may be processed as a control command from a user.

The output unit is to output a command processing result visibly, audibly, or tactually, and may include a display unit, an optical output unit, a speaker, a haptic output unit, and an optical output unit.

The embodiments of the present disclosure provided in the specification and the accompanying drawings are just predetermined examples for easily describing the technical contents of the present disclosure and helping understanding of the present disclosure, but the present disclosure is not limited thereto. It is apparent to those skilled in the technical field of the present disclosure that other modifications based on the technical idea of the present disclosure are possible.

What is claimed is:

1. An extended service-providing system which provides, using an API, an artificial intelligence prediction result associated with extended educational contents, the system comprising:
an access interface server to communicate with an extended service server that provides the extended educational contents to a terminal of a user; and
a learning content artificial intelligence server to communicate with the access interface server,
wherein the access interface server determines whether the user has an access authority to use the learning content artificial intelligence server if an API transmitted from the terminal is received via the extended service server, and
wherein the learning content artificial intelligence server, if the user is identified as having the access authority, transmits an artificial intelligence prediction result associated with the extended educational contents to the extended service server via the access interface server, in response to the API transmitted from the terminal

2. The system of claim 1, wherein the user includes an extended service registerer and an extended service user,
wherein the extended service registerer is a user who registers question data of the extended educational contents and actual score data with the learning content artificial intelligence server,
wherein the extended service user is a user who starts solving questions if an artificial intelligence model has performed training using the question data and the actual score data, and
wherein the system further comprises a question solving data storage to queue question solving data of the extended service user in order of solving questions, and to store the queued data in a storage space.

3. The system of claim 2, wherein the learning content artificial intelligence server comprises:
a user authentication unit to determine whether a user who desires to use the learning content artificial intelligence server is a user who is already registered with the learning content artificial intelligence server;
an extended service storage storing question data of the extended educational contents and artificial intelligence model information which is information associated with an artificial intelligence model to be used for each extended service; and
an artificial intelligence prediction unit to produce an artificial intelligence prediction result based on the question solving data received from the question solving data storage, with reference to artificial intelligence model information received from the extended service storage.

4. The extended service-providing system of claim 3, wherein the extended service storage comprises:
a learning content storage storing one or more of the question data which is initially registered by the extended service registerer, actual score data of the extended service user, a question recommendation history, a score prediction history, and an artificial intelligence model parameter for each extended service; and
a used data storage storing an amount of API used by the extended service user.

5. The system of claim 4, wherein the access interface server determines, based on the amount of API used by the extended service user, a cost to be charged to the extended service user.

6. The system of claim 2, wherein the API transmitted from the terminal includes one or more APIs among:
a registration API for registering the question data with the extended service storage of the learning content artificial intelligence server;
an inquiry API for identifying a subject, a tag, and a content related to the registered question data;
an artificial intelligence usage API for requesting an intelligence artificial prediction result including predicted scores and a predicted correct answer rate; and
a usage amount identification API for performing monitoring or identifying charging.

7. The system of claim 2, wherein the access interface server comprises a data conversion unit to add a client ID that differs for each extended service to one or more data among the question data, the actual score data, and the question solving data.

8. An extended service providing method which provides, using an API, an artificial intelligence prediction result associated with extended educational contents, the method comprising:
receiving, by an access interface server that communicates with an extended service server that provides the extended educational contents to a terminal of a user, an API transmitted from the terminal via the extended service server;
determining, by the access interface server, whether the user has an access authority to use a learning content artificial intelligence server;
if the user is identified as having the access authority, transmitting, by the learning content artificial intelligence server, an artificial intelligence prediction result associated with the extended educational contents to the extended service server via the access interface server in response to the API transmitted from the terminal; and
transmitting, by the extended service server, the artificial intelligence prediction result associated with the extended educational contents to the terminal of the user.
